(19) United States
(12) Patent Application Publication
(10) Pub. No.: US 2013/0330510 A1
(43) Pub. Date: Dec. 12, 2013

(54) Systems, Devices, and/or Methods for Fabricating Panels

(71) Applicants: Les Richard Gonda, Keswick, VA (US); Douglas Ted Queheillalt, Charlottesville, VA (US); Robert Kurtz, Charlottesville, VA (US); Russell Biagi, Charlottesville, VA (US); George Douglas Long, Charlottesville, VA (US); Richard Kerry Elzey, Barboursville, VA (US)

(72) Inventors: Les Richard Gonda, Keswick, VA (US); Douglas Ted Queheillalt, Charlottesville, VA (US); Robert Kurtz, Charlottesville, VA (US); Russell Biagi, Charlottesville, VA (US); George Douglas Long, Charlottesville, VA (US); Richard Kerry Elzey, Barboursville, VA (US)

(21) Appl. No.: 13/915,333

(22) Filed: Jun. 11, 2013

Related U.S. Application Data
(60) Provisional application No. 61/658,389, filed on Jun. 11, 2012.

(51) Int. Cl. B32B 3/26; B32B 3/28

(52) U.S. Cl. CPC B32B 3/266; B32B 3/28
USPC 428/138; 29/530

(57) ABSTRACT

Certain exemplary embodiments can provide a system, which can comprise an opposing pair of face sheets. Each of the opposing pair of face sheets can define a sheet longitudinal axis. The system can comprise a core adapted to separate and maintain a gap between the opposing pair of face sheets.

### CROSS-REFERENCES TO RELATED APPLICATIONS

This application claims priority to, and incorporates by reference herein in its entirety, pending U.S. Provisional Patent Application Ser. No. 61/658,389 (Attorney Docket No. 1022-003, filed 11 Jun. 2012.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a perspective view of an exemplary embodiment of a system, 1000;

FIG. 2 is a perspective view of an exemplary embodiment of a system 2000;

FIG. 3 is a perspective view of an exemplary embodiment of a system 3000;

FIG. 4 is a perspective view of an exemplary embodiment of a system 4000;

FIG. 5 is a perspective view of an exemplary embodiment of a system 5000; and

FIG. 6 is a flowchart of an exemplary embodiment of a method 6000.

### DETAILED DESCRIPTION

Certain exemplary embodiments can provide a system, which can comprise an opposing pair of face sheets. Each of the opposing pair of face sheets can define a sheet longitudinal axis. The system can comprise a core adapted to separate and maintain a gap between the opposing pair of face sheets.

Certain exemplary embodiments provide an opposing pair of face sheets separated by a core, gaps defined between the opposing face sheets and the core can be at least partially filled by an insulating material.

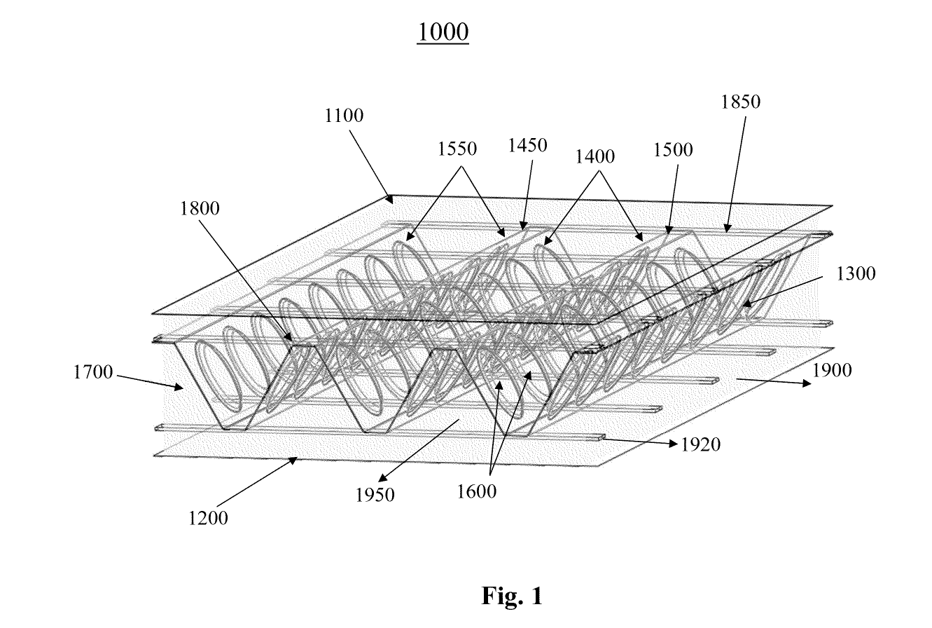

FIG. 1 is a perspective view of an exemplary embodiment of a system, 1000. In certain exemplary embodiments, a pair of opposing face sheets 1100 and 1200 is operatively coupled to a core 1300. Pair of opposing face sheets 1100 and 1200 can be substantially planar, can have corrugations, can be curved, and/or can comprise a textured surface. Core 1300 can be formed via bending substantially planar plates into a pattern having a chevron-like appearance (as illustrated) such that openings are defined between a pair of faces of the corrugation 1400 of chevron 1450. In system 1000, chevron 1450 has a node 1500. The substantially planar plates and be cut or perforated in a manner that reduces both the amount of material and weight relative to a substantially solid plate. For example, the plate illustrated in FIG. 1, which has been bent into a chevron pattern, defines a plurality of apertures 1600 on each face of each corrugation 1400. Plurality of apertures 1600 can be round as illustrated but can also, in other embodiments be square and/or triangular, etc. Core 1300 can be operatively coupled to pair of opposing face sheets 1100 and 1200 via a set of internal ribbons 1850 utilizing any of a plurality of fastening techniques, such as riveting, arc welding, spot welding, via an adhesive, and/or via forging or casting in a substantially unitary construction. Internal ribbons 1850 can provide additional structural support and/or stability to system 1000. Core 1300 can be fastened to internal ribbons 1850 at each location where node 1500 crosses internal ribbons 1850. In operative embodiments, fastening core 1300 to internal ribbons 1850 can result in a system in which a gap between opposing face sheets 1100 and 1200 is substantially maintained to a greater degree than alternative embodiments. Internal ribbons 1850 can effectively function as a face sheet reinforcement in terms of the structural properties of system 1000. In operative embodiments, when loading is on an upper face sheet, internal ribbons 1850 on the upper face sheet will be in compression, while internal ribbons 1850 on a lower face sheet will be in tension. Core 1300 can cause system 1000 to be relatively resistant to deformation caused by compressive forces applied to one or more of pair of opposing face sheets 1100 and 1200.

Each of opposing face sheets 1100 and 1200 can define a longitudinal axis 1900. Each of opposing face sheets 1100 and 1200 can be of any desired length, such as approximately, in feet, 0.1, 1, 2.1, 3, 4.45, 5.7, 6, 6.69, 8, 9.4, 10, 12, 14.18, 17.74, 20, 100, etc. and/or any value therein. Core 1300 defines a core axis 1950. In operative embodiments, longitudinal axis 1900 is substantially perpendicular to core axis 1950.

Openings and/or gaps defined by pair of opposing face sheets 1100 and 1200 and core 1300 can be filled with an insulating material 1700. For example, the openings or gaps can be filled with a spray type foam insulation, which can substantially reduce heat transfer through system 1000 when operatively installed as a part of a structure and/or larger system. Insulating material 1700 can be a ground and treated cellulosic or wood fiber product such as a loose fill insulation adapted for pneumatic or poured application. Such insulation can be produced from recycled paper that is chemically treated to be relatively non-toxic and/or resistant to fire, rodents, corrosion, fungus and other things that might cause deterioration. Insulating material 1700 can have a relatively high thermal insulative value.

System 1000 can be relatively light weight and low cost compared to other insulated panel systems. System 1000 can be modular and adapted for use in construction of building walls and/or roofs. Other potential applications of system 1000 comprise tanks, vessels, reactors, ships, vessels, airplanes, and/or automobiles, etc. By utilizing system 1000, certain buildings can be built with a larger distance between structural support members than might otherwise be possible.

As illustrated, the openings or gaps defined between the faces of the corrugation of each chevron can be substantially regular prismatic compartments 1800.

Certain exemplary embodiments provide a system 1000, which can comprise an opposing pair of face sheets 1100 and 1200. Each of opposing pair of face sheets 1100 and 1200 defining a sheet longitudinal axis 1900. Each of opposing pair of face sheets 1100 and 1200 can have corrugations, a textured surface, and/or be substantially planar. System 1000 can comprise core 1300, which is adapted to separate and maintain a gap between opposing pair of face sheets 1100 and 1200. Core 1300 can comprise a chevron 1450. Chevron 1450 can comprise a corrugation 1400. Chevron 1450 can comprise a node 1500. Each corrugation 1400 can comprise a pair of faces 1550. Each of pair of faces 1550 can define a plurality of apertures 1600. Each of plurality of apertures 1600 can be substantially circular, substantially rectangular, substantially triangular, and/or irregularly shaped, etc. Core 1300 defines a core axis 1950. Core axis 1950 can be substantially perpendicular to sheet longitudinal axis 1900.

System 1000 can comprise a set of internal ribbons 1850. Node 1500 can be directly coupled to set of internal ribbons 1850 at each location where node 1500 crosses one of set of internal ribbons 1850. A first subset of set of internal ribbons 1850 can be directly attached to first sheet 1100 of opposing pair of face sheets 1100 and 1200, and can be in tension. A second subset of set of internal ribbons 1850 can be directly attached to second sheet 1200 of opposing pair of face sheets 1100 and 1200 and can be in compression. Each of set of internal ribbons 1850 can comprise a thermally insulating material 1700 such that set of internal ribbons 1850 resists thermal bridging between core 1300 and pair of opposing face sheets 1100 and 1200. Each of set of internal ribbons 1850 defines a ribbon longitudinal axis 1920. Each ribbon longitudinal axis 1920 can be substantially perpendicular to core axis 1950. Core 1300 can be fastened to each of opposing pair of face sheets 1100 and 1200 via being directly fastened to set of internal ribbons 1850. Set of internal ribbons 1850 can be adapted to provide structural strength to assist in maintaining a gap between opposing pair of face sheets 1100 and 1200 when a force is applied to one of opposing pair of face sheets 1100 or 1200. System 1000 can comprise insulating material 1700 filling gaps defined between opposing pair of face sheets 1100 and 1200 and core 1300.

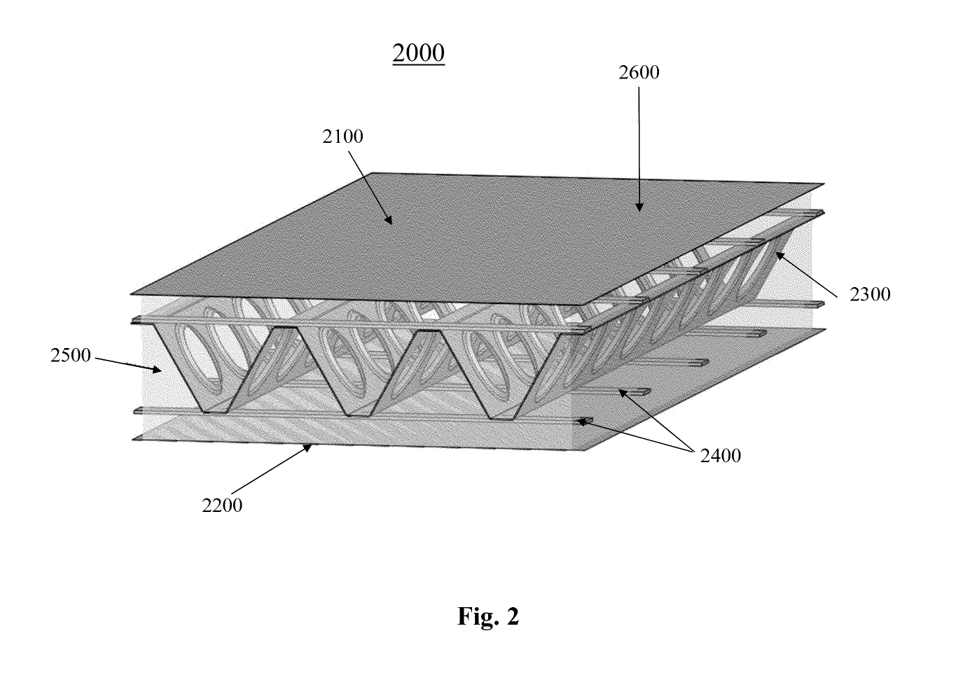

FIG. 2 is a perspective view of an exemplary embodiment of a system, 2000. In certain exemplary embodiments, a pair of opposing face sheets 2100 and 2200 is operatively coupled to core 2300. Openings and/or gaps defined by pair of opposing face sheets 2100 and 2200 and core 2300 can be filled with an insulating material 2500. Plurality of internal ribbons 2400 can be operatively coupled to pair of opposing face sheets 2100 and 2200 and/or core 2300. Plurality of internal ribbons 2400 can be adapted to provide additional stiffness to pair of opposing face sheets 2100 and to resist deformation responsive to external forces. In certain exemplary embodiments, plurality of internal ribbons 2400 can comprise a thermally insulating material and cause core 2300 to not touch opposing face sheets 2100 and 2200 and thereby prevent thermal bridging between core 2300 and opposing face sheets 2100 and 2200. Core 2300 can be adapted maintain a spacing between pair of opposing face sheets 2100 and 2200 and/or increase resistance of system 2000 to a reduction in spacing between pair of opposing face sheets 2100 and 2200 from a force 2600 applied to a surface of one of pair of opposing face sheets 2100 and 2200.

Pair of opposing face sheets 2100 and 2200 and/or core 2300 can be fabricated from metal, plastic, or other suitable material. In certain exemplary embodiments, core 2300 can be made of stretch metal and/or expanded metal.

System 2000 can have structural live load strength due to an internal core formed via core 2300 and/or plurality of internal ribbons 2400. This core strength is independent of opposing face sheets 2100 and 2200 and insulating material 2500. An advantage of certain exemplary embodiments is when building a roof; one can reduce or totally eliminate roof trusses. Another advantage can arise from labor reduction when assembling a roof; the roof structure is a total system (exterior surface, insulation, a painted internal surface, and the ceiling), not just a component.

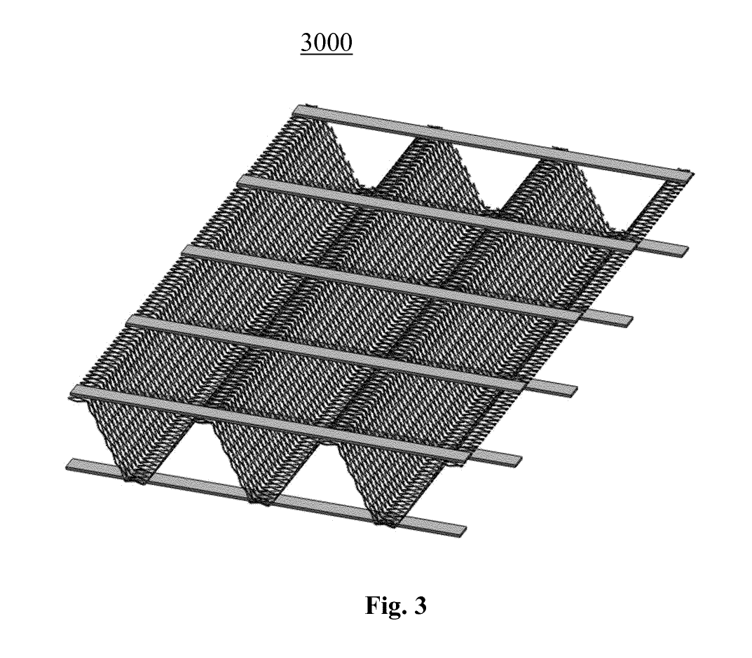

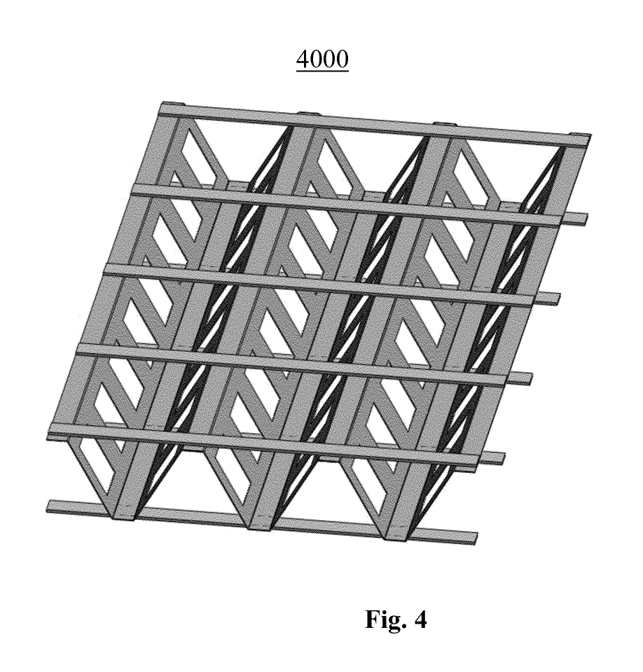

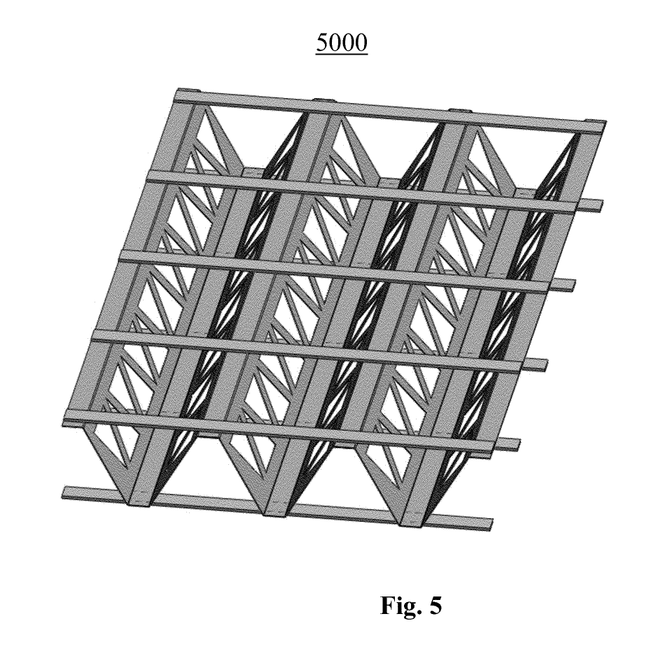

FIG. 3 is a perspective view of an exemplary embodiment of a system 3000. FIG. 4 is a perspective view of an exemplary embodiment of a system 4000. FIG. 5 is a perspective view of an exemplary embodiment of a system 5000.

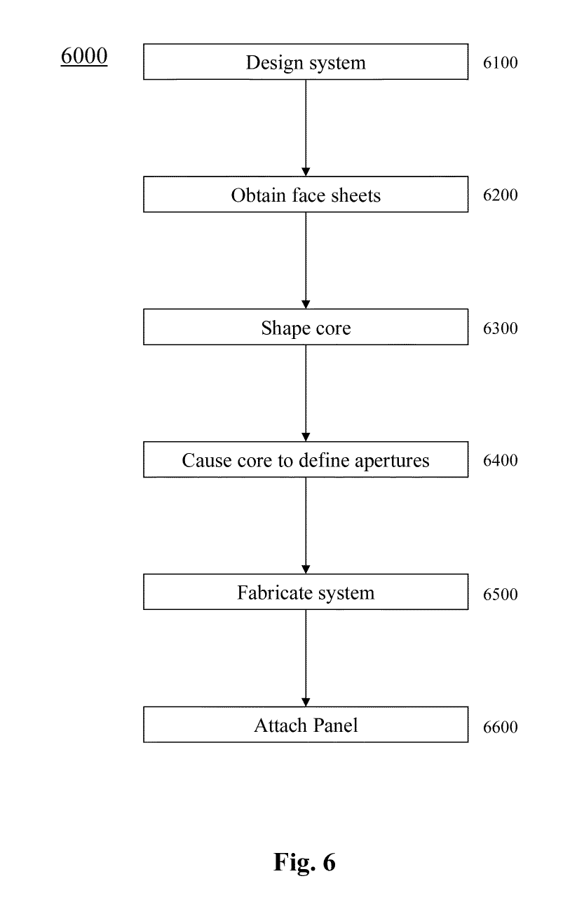

FIG. 6 is a flowchart of an exemplary embodiment of a method 6000. At activity 6100 a system can be designed. At activity 6200, face sheets can be obtained. In certain exemplary embodiments, the face sheets can be a pair of substantially planar face sheets. The face sheets can be made of a suitable material, such as a formable metal, plastic, or other suitable material.

At activity 6300, the core can be obtained and/or shaped. The core can be rolled, formed, bent, and/or shaped in a metal break in order to obtain a desired contour, such as a chevron contour comprising a node at the junction of each pair of faces of the corrugation. At activity 6400, the core can be caused to define apertures such each of the core define a plurality of apertures. In certain exemplary embodiments, the plurality of apertures can be cut or punched in the core.

At activity 6500, a system can be fabricated. The system can comprise an opposing pair of face sheets separated by a core. Gaps defined between the opposing face sheets and the core can be at least partially filled by an insulating material. Each of the opposing pair of face sheets defines a sheet longitudinal axis. The core can be adapted to maintain a gap between the opposing pair of face sheets. The core defines a core axis. The core axis can be substantially perpendicular to each sheet longitudinal axis. The system can comprise a set of internal ribbons. Each of the set of internal ribbons defines a ribbon longitudinal axis. Each ribbon longitudinal axis can be substantially perpendicular to the core axis. The core can be fastened to each of the opposing pair of face sheets via being directly fastened to one of the set of internal ribbons. The set of internal ribbons can be adapted to provide structural strength to assist in maintaining the gap between the opposing pair of face sheets when a force is applied to one of the opposing pair of face sheets.

The internal ribbons can be operatively coupled and/or fastened to the face sheets. The core can be fastened to the set of internal ribbons. The internal ribbons can comprise a thermally insulating material and/or can provide additional stiffness to the face sheets after being coupled thereto. The core can be releasably and/or fixedly coupled to the internal ribbons. The core can be operatively coupled and/or fastened to the face sheets via adhesive bonding, welding, brazing, and/or any other suitable fastening means. The plurality of internal ribbons can be adapted to provide additional stiffness to the opposing pair of face sheets and/or resist deformation responsive to external forces applied to one or more of the opposing pair of face sheets. Each of the set of internal ribbons can comprise a thermally insulating material such that the set of internal ribbons resists thermal bridging between the core and the pair of opposing face sheets. The face sheets can be operatively coupled to the core such that: the face sheets are opposing face sheets; the surfaces of the pair of face sheets are substantially parallel; the surfaces of the pair of face sheets are substantially non-parallel; and/or the face sheets are substantially non-planar and define a radius of curvature that is less than approximately 2 meters.

The core can be adapted to maintain spacing between the pair of face sheets. The core can be adapted to increase resistance of the panel to a reduction in spacing between the pair of opposing face sheets from a force applied to a surface of one of the pair of opposing face sheets. The gaps defined between the opposing face sheets and the core can be filled with the insulating material.

At activity 6600, a module comprising the face sheets and the core can be attached to a device and/or system. In certain exemplary embodiments, the device and/or system can comprise one or more ceilings, floor structures, walls, vehicular surfaces, vessel surfaces, and/or building surfaces, etc. The module can be adapted to thermally insulate the device and/or system. The system can be adapted to be installed as a part of a substantially truss-less building roof.

### DEFINITIONS

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
activity—an action, act, step, and/or process or portion thereof.
adapted to—made suitable or fit for a specific use or situation.
and/or—either in conjunction with or in alternative to.
aperture—an opening, hole, or gap.
assist—to aid.
can—is capable of, in at least some embodiments.
cause—to act in such a way that some specific thing happens as a result.
chevron—a pattern having a general V-shape.
circular—having a shape that is substantially a closed plane curve consisting of all points at an approximate given distance from a point within it called the center.
compression—subjection of a material or structure to pressure, which acts to reduce volume as compared to an uncompressed but otherwise substantially identical state.
comprising—including but not limited to.
connect—to join or fasten together.
core—a component used to maintain a separation between face sheets of a panel.
core axis—an imaginary line that is substantially parallel to a greatest dimension of a core node.
corrugation—a ridge or groove on a surface, the surface comprising a set of substantially parallel ridges and grooves.
coupleable—capable of being joined, connected, and/or linked together.
coupling—linking in some fashion.
define—to establish the outline, form, or structure of.
deformation—an action or process of changing in shape or distorting.
design—to plan the look and function of something before it is made.
device—a machine, manufacture, and/or collection thereof.
direct—substantially without any other intervening thing.
fabricate—to construct or manufacture.
face—an at least partially planar surface of an object.
fasten—to securely join.
fill—to put something into a space that substantially occupies that space.
force—a dynamic influence that acts to attempt to change a body from a state of rest to one of motion.
gap—a separation between two objects.
install—to connect or set in position and prepare for use.
insulating material—a substance adapted to substantially reduce a transfer of heat, electricity, or sound and having an R-value greater than approximately 1.0 m²K/w.
internal—inside of an object or system.
longitudinal axis—an imaginary line running down the approximate centre of a body in a direction of a greatest dimension of the body.
maintain—to cause to continue to be substantially unchanged.
method—a process, procedure, and/or collection of related activities for accomplishing something.
node—a region at which two at least partially planar object portions intersect.
opposing—positioned on opposite sides of a space.
partially—to some extent.
planar—having a substantially flat or level surface.
plurality—the state of being plural and/or more than one.
provide—to furnish, supply, give, and/or make available.
rectangular—having edges that meet at approximately right angles.
resist—to withstand an action or effect of.
ribbon—a strip of something that is relatively long compared to its width.
separate—to cause to be apart.
set—a related plurality.
sheet—a piece of material having a thickness that is significantly less than a width and length of the piece of material.
stiffness—a physical property of being relatively difficult to bend.
structural strength—an ability to withstand an applied force without suffering inelastic deformation.
substantially—to a great extent or degree.
support—to bear the weight of, especially from below.
system—a collection of mechanisms, devices, machines, articles of manufacture, processes, data, and/or instructions, the collection designed to perform one or more specific functions.
tension—subjection of a material or structure to pressure, which acts to stretch the material or structure.
textured surface—a relatively rough or grainy exposed portion of an object.
thermal bridging—a condition via which heat conduction occurs where the heat conduction is substantially unimpeded by any thermally insulating material.
thermally insulating material—a substance that reduces thermal energy transfer and has an R-value greater than approximately 1.0 m²K/w.
triangular—a shape having three sides and three corners.
truss-less building roof—a structure comprising a cover in which the cover is not supported by any system of structural member other than those comprised by building walls and roof panels.
via—by way of and/or utilizing.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A system comprising:
an opposing pair of face sheets, each of said opposing pair of face sheets defining a sheet longitudinal axis;
a core adapted to separate and maintain a gap between said opposing pair of face sheets, said core comprising a chevron, each of said chevrons comprising a corrugation, each corrugation comprising a pair of faces, each of said pair of faces defining a plurality of apertures,
said core defining a core axis;
a set of internal ribbons, each of said set of internal ribbons comprising a thermally insulating material such that said set of internal ribbons resists thermal bridging between said core and said pair of opposing face sheets, each of said set of internal ribbons defining a ribbon longitudinal axis, each ribbon longitudinal axis substantially perpendicular to said core axis, said core fastened to each of said opposing pair of face sheets via being directly fastened to one of said set of internal ribbons, said set of internal ribbons adapted to provide structural strength to assist in maintaining said gap between said opposing pair of face sheets when a force is applied to one of said opposing pair of face sheets; and
an insulating material filling gaps defined between said opposing pair of face sheets and said core.

2. The system of claim 1, wherein:
each of said opposing pair of face sheets has corrugations.

3. The system of claim 1, wherein:
said core axis is substantially perpendicular to each sheet longitudinal axis.

4. The system of claim 1, wherein:
each of said opposing pair of face sheets has a textured surface.

5. The system of claim 1, wherein:
each of said opposing pair of face sheets is substantially planar.

6. The system of claim 1, wherein:
each of said plurality of apertures is substantially circular.

7. The system of claim 1, wherein:
each of said plurality of apertures is substantially rectangular.

8. The system of claim 1, wherein:
each of said plurality of apertures is substantially triangular.

9. The system of claim 1, wherein:
a first subset of said set of internal ribbons is directly attached to a first sheet of said opposing pair of face sheets and is in tension; and
a second subset of said set of internal ribbons is directly attached to a second sheet of said opposing pair of face sheets and is in compression.

10. The system of claim 1, wherein:
each of said chevrons comprises a node, said node directly coupled to said set of internal ribbons at each location where said node crosses one of said set of internal ribbons.

11. A method comprising a plurality of activities, comprising:
fabricating a system comprising an opposing pair of face sheets separated by a core, gaps defined between said opposing face sheets and said core at least partially filled by an insulating material, each of said opposing pair of face sheets defining a sheet longitudinal axis, said core adapted to maintain a gap between said opposing pair of face sheets, said core defining a core axis, said core axis substantially perpendicular to each sheet longitudinal axis, said system comprising a set of internal ribbons, each of said set of internal ribbons defining a ribbon longitudinal axis, each ribbon longitudinal axis substantially perpendicular to said core axis, said core fastened to each of said opposing pair of face sheets via being directly fastened to one of said set of internal ribbons, said set of internal ribbons adapted to provide structural strength to assist in maintaining said gap between said opposing pair of face sheets when a force is applied to one of said opposing pair of face sheets.

12. The method of claim 11, further comprising:
causing said core to define a plurality of apertures.

13. The method of claim 11, further comprising:
filling said gap between said opposing face sheets with said insulating material.

14. The method of claim 11, further comprising:
fastening said opposing face sheets to said set of internal ribbons.

15. The method of claim 11, further comprising:
fastening said core to said set of internal ribbons.

16. The method of claim 11, further comprising:
designing said system.

17. The method of claim 11, wherein:
said system is adapted to be installed as a part of a substantially truss-less building roof.

18. The method of claim 11, wherein:
said plurality of internal ribbons are adapted to:
provide additional stiffness to said opposing pair of face sheets; and
resist deformation responsive to external forces applied to one or more of said opposing pair of face sheets.

19. The method of claim 11, wherein:
each of said set of internal ribbons comprises a thermally insulating material such that said set of internal ribbons resists thermal bridging between said core and said pair of opposing face sheets.
